(19) United States
(12) Patent Application Publication
(10) Pub. No.: US 2009/0002146 A1
(43) Pub. Date: Jan. 1, 2009

(54) METHOD AND APPARATUS FOR DETERMINING AND ASSOCIATING SENSOR LOCATION IN A TIRE PRESSURE MONITORING SYSTEM USING DUAL ANTENNAS

(75) Inventor: Xing Ping Lin, Orchard Lake, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignees: TRW Automotive U.S. LLC; Michelin Recherche et Technique S.A.

(21) Appl. No.: 12/147,158

(22) Filed: Jun. 26, 2008

Related U.S. Application Data
(60) Provisional application No. 60/937,482, filed on Jun. 28, 2007.

(51) Int. Cl. B60C 23/00

(52) U.S. Cl. 340/447

(57) ABSTRACT

A method for receiving data from and associating locations of a plurality of tire condition sensors in a vehicle comprises the step of mounting a first directional antenna in the vehicle oriented in a first direction to receive signals from an associated transmitter of at least some of said tire condition sensors. A second directional antenna is mounted in the vehicle oriented in a second direction to receive signals from an associated transmitter of others of said tire condition sensors. Signal strength of any received signals is determined, and sensor locations are determined by determining a differential signal value.

### CROSS-REFERENCE TO RELATED APPLICATION

The present application is a non-provisional application that claims priority from provisional application Ser. No. 60/937,482 filed in the name of Xing Ping Lin on Jun. 28, 2007 assigned to the same assignee of the present application, and entitled METHOD AND APPARATUS FOR DETERMINING AND ASSOCIATING SENSOR LOCATION IN A TIRE PRESSURE MONITORING SYSTEM USING DUAL ANTENNAS which is hereby fully incorporated herein by reference;

### TECHNICAL FIELD

The present invention is directed to a tire pressure monitoring system and, more particularly, to a method and apparatus for associating each tire-based monitoring device with a tire location on the vehicle.

### BACKGROUND OF THE INVENTION

Tire pressure monitoring systems having an associated tire-based pressure sensor and transmitter in each tire are known. The tire-based sensor inside a tire senses the pressure of its associated tire, and the tire-based transmitter transmits the sensed pressure, information to a vehicle mounted receiver. The vehicle mounted receiver is connected to a display that displays a warning to the vehicle operator when an under-inflated tire condition occurs.

Each tire-based transmitter within a tire has a unique identification code that is transmitted as part of the tire transmission signal. The vehicle-based receiver can be programmed with the identification codes and the associated tire locations so as to associate and display tire condition information appropriately.

### SUMMARY OF THE INVENTION

According to an example embodiment of the present invention, a method for receiving data from and associating locations of a plurality of tire condition sensors in a vehicle comprises the step of mounting a first directional antenna in the vehicle oriented in a first direction to receive signals from an associated transmitter of at least some of said tire condition sensors. A second directional antenna is mounted in the vehicle oriented in a second direction to receive signals from an associated transmitter of others of said tire condition sensors. Signal strength of any received signals is determined, and sensor locations are determined by determining a differential signal value.

In accordance with another example embodiment of the present invention, an apparatus for receiving data from and associating location of a plurality of tire condition sensors in a vehicle comprises a first directional antenna oriented in a first direction in the vehicle to receive signals from an associated transmitter of at least some of said tire condition sensors. The apparatus also comprises a second directional antenna oriented in a second direction in the vehicle to receive signals from an associated transmitter of others of said tire condition sensors. A circuit determines signal strength of any received signals, and a controller determines sensor locations by determining a differential signal value.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic block diagram of a vehicle including an example embodiment of the present invention;

FIG. 2 is a schematic block diagram of a vehicle including another example embodiment of the present invention;

FIG. 3 is a circuit diagram of an antenna circuit that may be included in the embodiment of FIG. 2; and

FIG. 4 is a circuit diagram of another antenna circuit that may be included in the embodiment of FIG. 2.

### DETAILED DESCRIPTION

Referring to FIG. 1, a vehicle 20, according to an example embodiment of the present invention, includes front left tire 22, front right tire 24, rear left tire 26, and rear right tire 28 at vehicle tire corner locations FL, FR, RL, and RR, respectively.

Each of the tires 22, 24, 26, and 28 includes an associated tire condition sensor 32, 34, 36, 38, respectively, mounted within the tire for sensing a condition of its associated tire such as pressure, temperature, etc. Each tire condition sensor 32, 34, 36, 38 includes an associated transmitter (not shown) that transmits a radio frequency (“RF”) signal having at least (a) an associated unique tire identification information code and (b) measured pressure information and/or temperature information as sensed by the sensor.

A vehicle-based receiver (“VBR”) 50 is mounted in the vehicle 20. The VBR 50 is adapted to receive RF signals from the associated transmitters of the tire condition sensors 32, 34, 36, and 38 and includes circuitry to determine the strength of the received RF signals known as received signal strength indication (“RSSI”) circuitry.

An electronic control unit (“ECU”) 60 is provided and is connected to the VBR 50. The ECU 60 receives from the VBR 50 signals that include the tire identification codes and sensor information, such as sensed tire pressure and/or temperature, received from the associated RF transmitters of the tire condition sensors 32, 34, 36, 38. The ECU 60 is connected to a display device 66 that displays to the vehicle operator any alert condition relating to a sensed tire condition that is out of specification. One skilled in the art will appreciate that continuous sensed data could be displayed in addition to or instead of alert condition information.

For the proper display of tire condition data, whether alert condition or continuous data, the ECU 60 must learn the tire identification code associated with each tire condition sensor located within each tire at each tire position. To accomplish this learning of identification codes associated with each tire condition sensor, a differential signal strength process or method is used that eliminates the effects of sensor variations and tire variations.

The VBR 50 includes a dual antenna arrangement to auto-locate or associate each of the tire condition sensors 32, 34, 36, 38 with a tire position. The VBR 50 may be equipped with more than two antennas. In accordance with an example embodiment, the VBR 50 includes two antennas 52 and 54. The antenna 52 is an external antenna, and the antenna 54 is an internal antenna. Both antennas 52 and 54 could be internal antennas. To reduce the cost, the external antenna 52 may be a simple wire connected to the connector used for the power/ground and data lines connection.

Because there are two antennas 52 and 54, there are two sets of data. Each data set comprises the four signals associated with the four tire condition sensors 32, 34, 36, and 38. If a spare tire is provided, there will be five tire condition sensors and, therefore, five signals in each data set. With regard to the four sensor differential signal strength process or method described below, it is relatively easy to identify the tire condition sensor mounted in the spare tire because its signal will have the minimal change over the time during driving.

The differential signal strength process or method of the invention uses RSSI values determined by the RSSI circuitry. In general, if the VBR 50, including the antennas 52 and 54, is mounted closer to one tire, e.g., tire 28, than to the other tires, as shown in FIG. 1, the signal with highest RSSI value received by each of the antennas will be received from and indicate the tire condition sensor 38 in the close tire 28. If the antennas 52 and 54 are properly oriented directional antennas, signals with lower RSSI values will be received from the tire condition sensors, e.g., sensors 34 and 36, as shown in FIG. 1, toward which the antennas 52 and 54 are oriented. Signals with the lowest RSSI values will be received from the tire condition sensors that are laterally offset from the directions in which the antennas 52 and 54 are oriented, e.g., sensors 32 and 36 for antenna 52 and sensors 32 and 34 for antenna 54. The two antennas 52 and 54 of the embodiment of FIG. 1 are directional antennas and one antenna, e.g., antenna 52, is oriented toward one tire condition sensor, e.g., sensor 34, and its associated transmitter (not shown) and the other antenna, e.g., antenna 54, is oriented toward another tire condition sensor, e.g., sensor 36, and its associated transmitter (not shown).

In accordance with the invention, both the RSSI signal values and differential RSSI signal values can be used to identify the four tire condition sensors 32, 34, 36, and 38 and associate them with the four tire corner locations FL, FR, RL, and RR, respectively. The differential RSSI signal values (RSSI at antenna 52 minus RSSI at antenna 54) are particularly useful when the separation between the individual RSSI signal values is not large. The advantage of using differential RSSI signal values is that the differential RSSI signal values are independent of tire variations and sensor variations. The apparatus mounting arrangements and associated process or method described below have been shown to be useful in generally every vehicle.

In the embodiment of FIG. 1, the tire condition sensors 34 and 38 on the right side of the vehicle 20 create a strong field on the right side due to the vehicle's metal structure, and the tire condition sensors 32 and 36 on the left side of the vehicle create a strong field on the left side due to the vehicle's metal structure. Similarly, the tire condition sensors 36 and 38 adjacent the rear of the vehicle 20 create a strong field in the rear area. Consequently, by placing the VBR 50 closer to the right rear tire 28, but under the vehicle 20 and a short distance from the right side of the vehicle, the internal antenna 54 can be used to distinguish between the tire condition sensors 32 and 34 closer to the front of the vehicle and the tire condition sensors 36 and 38 closer to the rear of the vehicle. The external antenna 52, which is a wire extending to the right and routed along the plastic bumper strip on the right side of the vehicle 20, can be used to distinguish the tire condition sensors 34 and 38 on the right side of the vehicle from the tire condition sensors 32 and 36 on the left side of the vehicle.

The two charts below illustrate the relative RSSI values that can be expected from the signals associated with the four different tire condition sensors 32, 34, 36, and 38 at the two antennas 52 (Ant_Out) and 54 (Ant_In) in the embodiment of FIG. 1. The first chart indicates the sensors for which the relative RSSI values are given on the left side of the second chart.

Ant_Out

| | | | | |
|---|---|---|---|---|
| Ant_In | FL | FR | FL | FR |
| | RL | RR | RL | RR |

| | | | | | Ant_In + Ant_Out | | | Ant_In − Ant_out | | |
|---|---|---|---|---|---|---|---|---|---|---|
| | | | Ant_Out | | Antenna | Ant_Out | | Antenna | Ant_Out | |
| Ant_In | 1 | 1 | 1 | 2 | Ant_In | 2 | 3 | Ant_In | 0 | −1 |
| | 2 | 3 | 1 | 3 | | 3 | 6 | | 1 | 0 |

The highest sum of the RSSI values [6] at the two antennas (Ant_In+Ant_Out) for a particular sensor determines that the sensor is positioned at the rear right (RR) tire corner location.
The lowest sum of the RSSI values [2] at the two antennas (Ant_In+Ant_Out) for a particular sensor in combination with the least difference between the RSSI values [0] at the two antennas (Ant_In−Ant_Out) for the sensor determines that the sensor is positioned at the front left (FL) tire corner location.
The second highest RSSI value [2] at antenna 52 (Ant_Out) for a particular sensor in combination with the lowest calculated difference between the RSSI values [−1] at the two antennas (Ant_In−Ant_Out) for the sensor determines that the sensor is positioned at the front right (FR) tire corner location.
The second highest RSSI value [2] at antenna 54 (Ant_In) for a particular sensor in combination with the highest calculated difference between the RSSI values [1] at the two antennas (Ant_In−Ant_Out) for the sensor determines that the sensor is positioned at the rear left (RL) tire corner location.

With the VBR 50 placed in a generally rear right position, internal antenna 54 is under the vehicle 20 and away from any edge of the vehicle. External antenna 52 extends along the right side of the vehicle 20. As previously mentioned, the main purpose of the internal antenna 54 is to determine the rear tire condition sensors 36 and 38. The main purpose of the external antenna 52 is to determine the right side tire condition sensors 34 and 38. With a wire antenna, as used for external antenna 52, it is possible to use the same connector for both the power and data lines. No extra connector or RF connector is required.

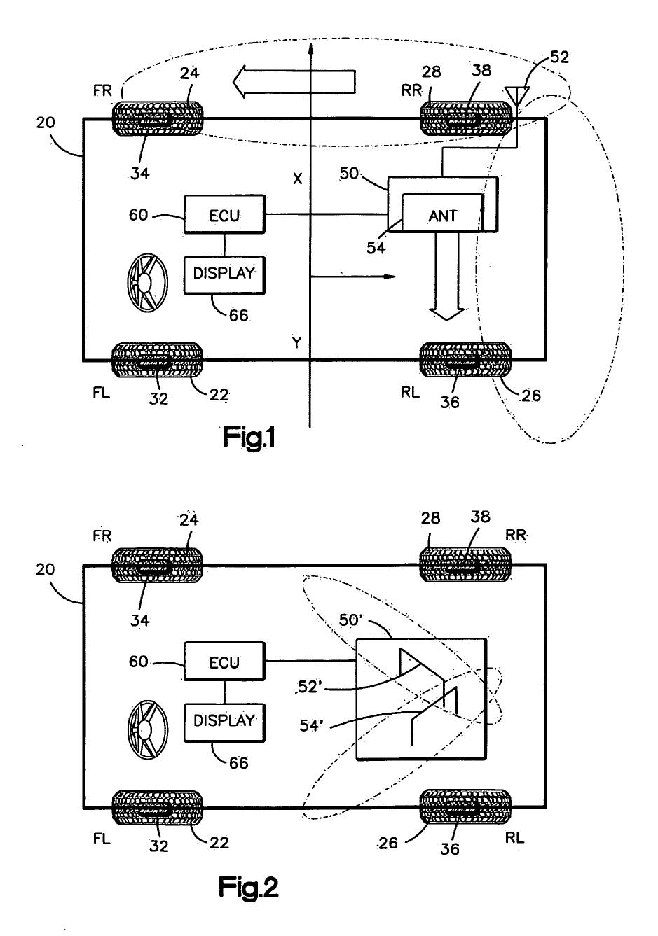

In accordance with another embodiment of the present invention, FIG. 2 shows a closed loop antenna system in which two closed loop antennas 52′ and 54′ are used instead of the antennas 52 and 54 of the embodiment of FIG. 1. In other respects, the embodiment of FIG. 2 includes the same hardware elements as the embodiment of FIG. 1. Referring to FIG. 2, the VBR or antenna assembly 50′ includes two internal loop antennas 52′ and 54′ that are placed substantially orthogonal to each other. The loop antennas 52′ and 54′ are small compared to the radio signal wavelength. As with the embodiment of FIG. 1, because there are two antennas, there are two sets of data. Each data set comprises the four signals associated with the four tire condition sensors 32, 34, 36, and 38. Again, if a spare tire is used, there will be five tire condition sensors and, therefore, five signals in each data set. With regard to the four sensor differential signal strength process or method described below, it is relatively easy to identify the spare tire in that its signal will have the minimum change over time during driving.

The differential signal strength method or process of the invention uses RSSI values determined by the RSSI circuitry. In general, if the VBR 50′ is mounted closer to the one of the tires, e.g., tire 26, as shown in FIG. 2, than to the other tires, the signal with highest RSSI value received by each of the antennas 52′ and 54′ will be received from and indicate the tire condition sensor 36 in the close tire 26. If the antennas 52′ and 54′ are properly oriented directional antennas, signals with lower RSSI levels will be received from the associated transmitters (not shown) of tire condition sensors, e.g., sensors 32 and 34, as shown in FIG. 2, at the end of the vehicle 20 (i.e., the front of the vehicle in FIG. 2) that is opposite the end adjacent to which the tire condition sensor 36 is located.

The two antennas 52′ and 54′ of the embodiment of FIG. 2 are directional antennas and are arranged with one antenna, e.g., antenna 52′, oriented toward one tire condition sensor, e.g., sensor 34, and the other antenna, e.g., antenna 54′, oriented toward the other tire condition sensor, e.g., sensor 32. Thus, in effect, the null of internal loop antenna 52′ is presented generally toward the tire 22 and its tire condition sensor 32, and the beam of internal loop antenna 52′ is oriented generally toward the tire 24 and its tire condition sensor 34. The internal loop antenna 54′ is oppositely arranged. In other words, the null of internal loop antenna 54′ is presented generally toward the tire 24 and its tire condition sensor 34, and the beam of internal loop antenna 54′ is oriented generally toward the tire 22 and its tire condition sensor 32.

In accordance with the invention, both the RSSI signal values and differential RSSI signal values (e.g., RSSI at antenna 52′ minus RSSI at antenna 54′) can be used to identify the four tire condition sensors 32, 34, 36, and 38 and associate them with the four different tire corner locations FL, FR, RL, and RR, respectively. The advantage of using differential RSSI signal values is that the differential RSSI signal values are independent of tire variations and sensor variations.

In the embodiment of FIG. 2, the VBR 50′ is mounted close to the rear left (RL) vehicle tire corner location. The beam from antenna 54′ is directed toward the FL vehicle tire corner location and tire condition sensor 32 and its associated transmitter (not shown). The null from antenna 54′ is directed toward the FR vehicle tire corner location and tire condition sensor 34. The exact angle of the antenna 54′ with respect to the longitudinal axis of the vehicle 20 can be determined according to the vehicle's structure. The beam from antenna 52′ is directed toward the FR vehicle tire corner location and tire condition sensor 34 and its associated transmitter (not shown). The null from antenna 52′ is directed toward the FL vehicle tire corner location and tire condition sensor 32. Again, the exact angle of the antenna 52′ with respect to the longitudinal axis of the vehicle 20 can be determined according to the vehicle's structure.

From the foregoing arrangement of the antennas 52′ and 54′ relative to the tire condition sensors 32, 34, 36, and 38, the tire condition sensors can be identified and associated with the four different tire corner locations FL, FR, RL, and RR, respectively. Specifically, as previously described, the tire condition sensor with the highest RSSI value at each of the antennas 52′ and 54′ is determined to be at the rear left (RL) tire corner location. Alternatively, this tire condition sensor can be identified by computing the sum of the RSSI values for each tire condition sensor at each antenna and identifying the tire condition sensor with the highest sum of RSSI values at the two antennas as being at the rear left (RL) tire corner location.

To identify the tire condition sensors at the front left (FL) and front right (FR) tire corner locations, the antennas 52′ and 54′ are turned on separately to identify the tire condition sensor with the next highest RSSI value at each antenna. The tire condition sensor with the next highest RSSI value at antenna 52′ is identified as being the tire condition sensor at the FR tire corner location. The tire condition sensor with the next highest RSSI value at antenna 54′ is identified as being the tire condition sensor at the FL tire corner location. If there is any ambiguity, the following differential values are computed (where, for example, FL_Ant1 means the RSSI value from the tire condition sensor presumed to be at the FL vehicle tire corner location as determined at the antenna 54′ (Ant1)):

FL_Ant1−FL_Ant2 (1)

FR_Ant1−FR_Ant2 (2)

If

(FL_{—}Ant1−FL_{—}Ant2)>0

then the tire condition sensor at the FL tire corner location has been properly identified.

Likewise, if

(FR_{—}Ant1−FR_{—}Ant2)<0

then the tire condition sensor at the FR tire corner location has been properly identified.

Finally, the tire condition sensor with the smallest change in RSSI value between antenna 52′ and antenna 54′ is identified as being the tire condition sensor at the RR tire corner location.

As previously mentioned, there may be difficulty in identifying the tire condition sensors at the FL and FR tire corner locations. This ambiguity may result from variations in the tires 22, 24, 26 and 28 or variations in the tire condition sensors 32, 34, 36, and 38. To resolve such ambiguities, the differential RSSI values described above can be computed. The differential RSSI values are independent of power variations in that tire condition sensors 32, 34, 36, and 38 and variations in the tires 22, 24, 26 and 28, as illustrated below:

X=FL_{—}Ant1−FL_{—}Ant2, (1)

Y=FR_{—}Ant1−FR_{—}Ant2 (2)

Z=X−Y (3)

Z=(FL_{—}Ant1−FL_{—}Ant2)−(FR_{—}Ant1−FR_{—}Ant2) (4)

As previously described, the antenna 1 beam is directed toward or focused on the FL vehicle tire corner location, the antenna 2 beam is directed toward or focused on the FR vehicle tire corner location, and the antenna 2 null is presented generally toward the FL vehicle tire corner location.

So

(FL_{—}Ant1−FL_{—}Ant2)>0 (5)

regardless of the RSSI values of FL_Ant1 and FL_Ant2.

The reverse is true for the FR vehicle tire corner location.

(FR_{—}Ant1−FR_{—}Ant2)<0 (6)

regardless of the RSSI values of FR_Ant1 and FR_Ant2.

So,

Z>0 (7)

This is true regardless of sensor power variations and tire variations. Since the values X and Y determined according to equations (1) and (2), respectively, are differential values, they are independent of the sensor power number. For example, if the power of the tire condition sensor 32 at the FL vehicle tire corner location is 10 dB lower than the power of the tire condition sensor 34 at the FR vehicle tire corner location sensor, equation (1) becomes:

X=(FL_{—}Ant1−10)−(FL_{—}Ant2−10)=FL_{—}Ant1−FL_{—}Ant2

Thus, there is no change for X.

As to Z:

$$\begin{matrix}Z = [ ( FL\_Ant1 - 10 ) - ( FL\_Ant2 - 10 ) ] - ( FR\_Ant1 - FR\_Ant2 ) \\ = ( FL\_Ant1 - FL\_Ant2 ) - ( FR\_Ant1 - FR\_Ant2 )\end{matrix}$$

Thus, there is also no change for Z.

This demonstrates that the differential RSSI values are independent of the sensor power variation. The differential RSSI values should be also independent of the tire attenuation variations.

Another factor that may interfere with the identification of the tire condition sensors 32, 34, 36, and 38 and the association of the tire condition sensors with the tire corner locations is the proximity of the antennas and the possible sharing of the same grounding structure by the antennas. With particular reference to antennas 52′ and 54′ of the embodiment of FIG. 2, turning on the antennas separately so that one antenna is ON while the other antenna is OFF may not be sufficient to permit each antenna to identify the tire condition sensor 34 or 32 toward which the antenna is oriented. To permit independent functioning of the antennas 52′ and 54′, it may be desirable selectively to change the impedance matching or resonating of each antenna, in turn, so that the unwanted or non-selected antenna is resonating outside of the operating frequency range of the antennas.

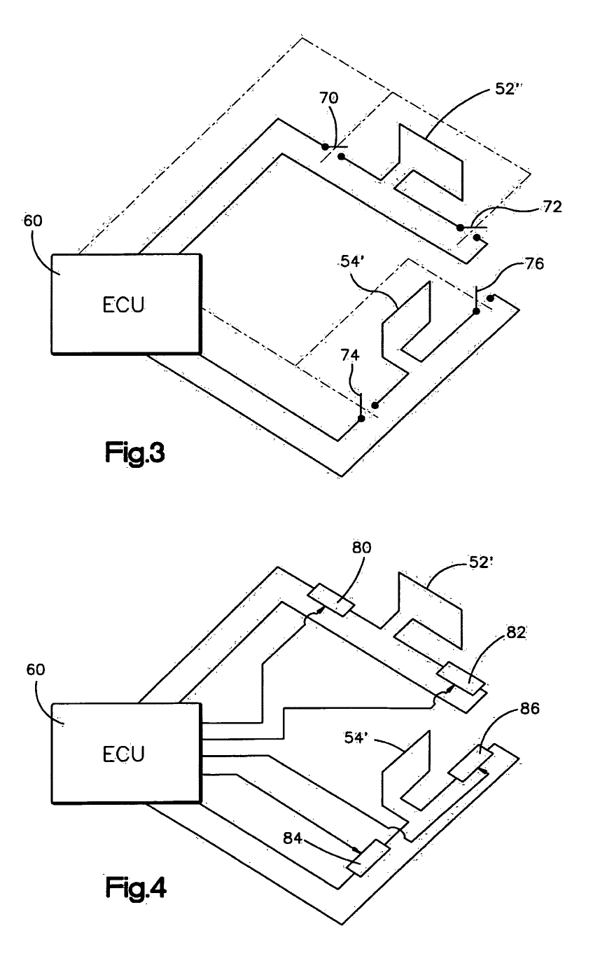

One example arrangement for achieving such impedance switching of antennas 52′ and 54′ is shown in FIG. 3. In FIG. 3, loop antenna 52′ is connected to the ECU 60 and other components of the antenna circuit through two switches 70 and 72. By opening both switches 70 and 72, the antenna 52′ is electrically isolated from other electrical components. Similarly, loop antenna 54′ is connected to the ECU 60 and other components of the antenna circuit through two switches 74 and 76. By opening both switches 74 and 76, the antenna 52′ is electrically isolated from other electrical components. As shown, opening and closing of the switches 70, 72, 74 and 76 is controlled by the ECU 60. A similar arrangement of switches can be used with the embodiment of FIG. 1.

Another example arrangement for achieving impedance switching of antennas 52′ and 54′ is shown in FIG. 4. In FIG. 4, loop antenna 52′ is connected to the ECU 60 and other components of the antenna circuit through two controllable impedance devices 80 and 82. By controlling both devices 80 and 82, the antenna 52′ can be effectively isolated from other electrical components. Similarly, loop antenna 54′ is connected to the ECU 60 and other components of the antenna circuit through two controllable impedance devices 84 and 86. By controlling both controllable impedance devices 84 and 86, the antenna 54′ can be effectively isolated from other electrical components. As shown, the ECU 60 controls the controllable impedance devices 80, 82, 84 and 86 sufficiently to change the operating frequency of each antenna 52′ and 54′ selectively so that if is out of the normal operating frequency range of the antennas. A similar arrangement of controllable impedance devices can be used with the embodiment of FIG. 1.

Although it is desirable for the loop antennas 52′ and 54′ to be oriented substantially perpendicular to each other, the present invention is not limited to that orientation. The present invention contemplates other orientations.

From the above description of the invention, those skilled in the art will perceive improvements, changes and modifications. Such improvements, changes and modifications within the skill of the art are intended to be covered by the appended claims.

Having described the invention, the following is claimed:

1. A method for receiving data from and associating locations of a plurality of tire condition sensors in a vehicle comprising the steps of:
mounting a first directional antenna in the vehicle oriented in a first direction to receive signals from an associated transmitter of at least some of said tire condition sensors;
mounting a second directional antenna in the vehicle oriented in a second direction to receive signals from an associated transmitter of others of said tire condition sensors;
determining signal strength of any received signals; and
determining sensor locations by determining a differential signal value.

2. The method of claim 1 wherein said step of mounting said first directional antenna in the vehicle oriented in a first direction includes mounting said first directional antenna closer to one of the associated transmitters of the tire condition sensors than to the associated transmitters of other tire condition sensors, and the step of mounting a second directional antenna in the vehicle oriented in a second direction includes mounting said second directional antenna closer to said one of the associated transmitters of the tire condition sensors than to the associated transmitters of said other tire condition sensors.

3. The method of claim 2 wherein said step of mounting a first directional antenna oriented in the vehicle in a first direction includes orienting said first directional antenna toward an associated transmitter of a first tire condition sensor along a side of the vehicle, and the step of mounting a second directional antenna in the vehicle oriented in a second direction includes orienting said second directional antenna toward an associated transmitter of a second tire condition sensor adjacent an end of the vehicle.

4. The method of claim 2 wherein said step of mounting a first directional antenna in the vehicle oriented in a first direction includes orienting said first directional antenna toward an associated transmitter of a first tire condition sensor at an end of the vehicle opposite said one of the transmitters of the tire condition sensors, and the step of mounting a second directional antenna in the vehicle oriented in a second direction includes orienting said second directional antenna toward an associated transmitter of a second tire condition sensor at said end of the vehicle opposite said one of the transmitters.

5. The method of claim 2 wherein said steps of mounting a first directional antenna in the vehicle oriented in a first direction and mounting a second directional antenna in the vehicle oriented in a second direction includes include orienting said first and second directional antennas so as to be substantially orthogonal to each other.

6. The method of claim 1 wherein each of said associated transmitters transmits a sensor identification and a sensed tire condition, and wherein said step of determining sensor locations by determining a differential signal value includes calculating a difference between the determined signal strength of a signal received by said first directional antenna from an associated transmitter of a first tire condition sensor and the determined signal strength of a signal received by said second directional antenna from said associated transmitter of said first tire condition sensor.

7. The method of claim 6 wherein said step of determining sensor locations by determining a differential signal value also includes calculating a difference between the determined signal strength of a signal received by said first directional antenna from an associated transmitter of a second tire condition sensor and the determined signal strength of a signal received by said second directional antenna from said associated transmitter of said second tire condition sensor.

8. The method of claim 1 wherein said step of determining sensor locations by determining a differential signal value includes calculating a difference between the determined signal strength of a signal received by said first directional antenna from an associated transmitter of each tire condition sensor and the determined signal strength of a signal received by said second directional antenna from said associated transmitter of the same tire condition sensor.

9. The method of claim 8 wherein said step of determining sensor locations by determining a differential signal value also includes calculating a sum of the determined signal strength of a signal received by said first directional antenna from an associated transmitter of each tire condition sensor and the determined signal strength of a signal received by said second directional antenna from said associated transmitter of the same tire condition sensor.

10. The method of claim 9 wherein said step of determining sensor locations by determining a differential signal value also includes determining one sensor location based on at least the lowest calculated difference between the determined signal strengths of said signals received by said first and second directional antennas from the associated transmitter of each tire condition sensor, determining a second sensor location based on at least the highest calculated difference between the determined signal strengths of said signals received by said first and second directional antennas from the associated transmitter of each tire condition sensor, and determining a third sensor location based on at least the smallest absolute value of the calculated differences between the determined signal strengths of said signals received by said first and second directional antennas from the associated transmitter of each tire condition sensor.

11. The method of claim 1 further comprising the step of selecting one of said first and second directional antennas to receive signals from associated transmitters of said tire condition sensors, said step of selecting one of said first and second directional antennas including at least one of (a) changing a resonating frequency of the other of said first and second directional antennas through antenna impedance matching and (b) switching off the other of said first and second directional antennas.

12. The method of claim 11 further comprising the step of selecting the other of said first and second directional antennas to receive signals from associated transmitters of said tire condition sensors, said step of selecting the other of said first and second directional antennas including reversing the step of selecting the one of said first and second directional antennas and also at least one of (a) changing a resonating frequency of the one of said first and second directional antennas through antenna impedance matching and (b) switching off the one of said first and second directional antennas.

13. An apparatus for receiving data from and associating locations of a plurality of tire condition sensors in a vehicle comprising:
a first directional antenna oriented in a first direction in the vehicle to receive signals from an associated transmitter of at least some of said tire condition sensors;
a second directional antenna oriented in a second direction in the vehicle to receive signals from an associated transmitter of others of said tire condition sensors;
a circuit for determining signal strength of any received signals; and
a controller for determining sensor locations by determining a differential signal value.

14. The apparatus of claim 13 wherein said first directional antenna is mounted closer to one of the associated transmitters of the tire condition sensors than to the associated transmitters of other tire condition sensors, and said second directional antenna is mounted closer to said one of the associated transmitters of the tire condition sensors than to the associated transmitters of other tire condition sensors.

15. The apparatus of claim 14 wherein said first directional antenna is oriented toward an associated transmitter of a first tire condition sensor along a side of the vehicle along a side of the vehicle, and said second directional antenna is oriented toward an associated transmitter of a second tire condition sensor adjacent an end of the vehicle.

16. The apparatus of claim 14 wherein said first directional antenna is oriented toward an associated transmitter of a first tire condition sensor at an end of the vehicle opposite an end adjacent to which said one of the associated transmitters of the tire condition sensors is located, and said second directional antenna is oriented toward an associated transmitter of a second tire condition sensor at said end of the vehicle opposite the end adjacent to which said one of the associated transmitters of the tire condition sensors is located.

17. The apparatus of claim 14 wherein said first and second directional antennas are mounted so as to be substantially orthogonal to each other.

18. The apparatus of claim 14 wherein said first and second directional antennas are both closed loop antennas.

19. The apparatus of claim 13 wherein each of said transmitters transmits a sensor identification and a sensed tire condition, and said controller calculates a difference between the determined signal strength of a signal received by said first directional antenna from an associated transmitter of a first tire condition sensor and the determined signal strength of a signal received by said second directional antenna from said associated transmitter of said first tire condition sensor.

20. The apparatus of claim 19 wherein said controller calculates a difference between the determined signal strength of a signal received by said first directional antenna from an associated transmitter of a second tire condition sensor and the determined signal strength of a signal received by said second directional antenna from said associated transmitter of said second tire condition sensor.

21. The apparatus of claim 13 wherein said controller calculates a difference between the determined signal strength of a signal received by said first directional antenna from an associated transmitter of each tire condition sensor and the determined signal strength of a signal received by said second directional antenna from said associated transmitter of the same tire condition sensor.

22. The apparatus of claim 21 wherein said controller calculates a sum of the determined signal strength of a signal received by said first directional antenna from ah associated transmitter of each tire condition sensor and the determined signal strength of a signal received by said second directional antenna from said associated transmitter of the same tire condition sensor.

23. The apparatus of claim 22 wherein said controller determines one sensor location based on at least the lowest calculated difference between the determined signal strengths of said signals received by said first and second directional antennas from the associated transmitter of each tire condition sensor, a second sensor location based on at least the highest calculated difference between the determined signal strengths of said signals received by said first and second directional antennas from the associated transmitter of each tire condition sensor, and a third sensor location based on at least the smallest absolute value of the calculated differences between the determined signal strengths of said signals received by said first and second directional antennas from the associated transmitter of each tire condition sensor.

24. The apparatus of claim 13 further comprising at least one controllable device for effecting at least one of (a) a change in a resonating frequency of at least one of said first and second directional antennas through antenna impedance matching and (b) a switching off of said at least one of said first and second directional antennas, said controller controlling said controllable device.
